(19) United States
(12) Patent Application Publication
(10) Pub. No.: US 2026/0103147 A1
(43) Pub. Date: Apr. 16, 2026

(54) Vehicle Step Assembly

(71) Applicant: NAADE, Inc. dba Go Rhino Products, Ann Arbor, MI (US)

(72) Inventors: Timothy J. Wymore, Ann Arbor, MI (US); Jason Gauci, Cumming, GA (US)

(21) Appl. No.: 19/357,541

(22) Filed: Oct. 14, 2025

Related U.S. Application Data
(60) Provisional application No. 63/707,576, filed on Oct. 15, 2024.

(51) Int. Cl. B60R 3/02; B60Q 1/24

(52) U.S. Cl. CPC B60R 3/02; B60Q 1/247

(57) ABSTRACT

A retractable vehicle step assembly for a vehicle includes a retractable vehicle step movably coupled to the vehicle. The retractable vehicle step is movable relative to the vehicle between a stowed position and a deployed position. The retractable vehicle step assembly includes an actuator coupled to the retractable vehicle step. The retractable vehicle step is configured to move between the stowed position and the deployed position upon activation of the actuator. The retractable vehicle step assembly further includes a sensor in communication with the actuator. The sensor is configured to detect an event and generate a control signal upon detection of the event. The sensor is configured to transmit the control signal to the actuator. The actuator is configured to actuate in response to receiving the control signal from the sensor to move the retractable vehicle step between the stowed position and the deployed position.

### FIELD

The present disclosure generally relates to vehicles and, in particular, to vehicle step assemblies to facilitate access to a cargo area, interior, roof, tailgate or other area of a vehicle, such as a pickup truck.

### BACKGROUND

Some vehicles, such as pickup trucks, include a stepping assist to facilitate access to the cargo bed or other cargo area. Other stepping assists, such as running boards, are attached to a side of the vehicle to allow a user to climb into the vehicle passenger compartment. However, these stepping assists have some drawbacks. For instance, the position of these stepping assists cannot be adjusted based on a user’s height. Also, some current step assists remain stationary and cannot be stowed while not in use. It is therefore desirable to develop a step assist that addresses the drawbacks of the current stepping assists.

### SUMMARY

The present disclosure describes step assists, such as step assemblies, for vehicles. In an aspect of the present disclosure, a retractable vehicle step assembly for a vehicle includes a retractable vehicle step movably coupled to the vehicle. The retractable vehicle step is movable relative to the vehicle between a stowed position and a deployed position. The retractable vehicle step assembly includes an actuator coupled to the retractable vehicle step. The retractable vehicle step is configured to move between the stowed position and the deployed position upon activation of the actuator. The retractable vehicle step assembly further includes a sensor in (wired or wireless) communication with the actuator. The sensor is configured to detect an event and generate a control signal upon detection of the event. The sensor is configured to transmit the control signal to the actuator in response to detecting the event. The actuator is configured to actuate in response to receiving the control signal from the sensor to move the retractable vehicle step between the stowed position and the deployed position.

In some aspects of the present disclosure, the sensor may be a motion sensor configured to detect the movement of a user. For example, the motion sensor may be attached to the bottom surface of a bumper of a vehicle to detect a foot motion of the user under the bumper of the vehicle.

In some aspects of the present disclosure, the control signal may originate from a portable electronic device (e.g., smartphone) located remotely relative to the vehicle. The retractable vehicle step assembly further includes a receiver configured to wirelessly receive the control signal and/or other signals from the portable electronic device. The portable electronic device includes a computer and a transmitter in communication with the computer. The computer includes a processor and a non-transitory computer readable medium in communication with the processor. The computer is programmed to run an application to command the transmitter to wirelessly transmit the control signal to the receiver upon receipt of an input from a user.

In certain aspects of the present disclosure, the sensor may be a magnetic switch coupled to a tailgate of the vehicle. The tailgate is movable relative to a vehicle body between an open position and a closed position. The magnetic switch is configured to detect when the tailgate moves between the open position and the closed position. The magnetic switch may be configured to transmit the control signal to the actuator upon movement of the tailgate between the open position and the closed position. The actuator is configured to actuate upon receipt of the control signal from the magnetic switch to move the retractable vehicle step between the stowed position and the deployed position.

In certain aspects of the present disclosure, the retractable vehicle step includes a step body. The step body defines an uppermost surface. The step body may be wholly or partly made of a metallic material, such as aluminum. The retractable vehicle step assembly further includes a stepping layer disposed on top the uppermost surface of the step body. The stepping layer may be removable from the step body. The stepping layer is wholly or partly made of a polymeric material and has a plurality of threads. The polymeric material may be a closed-cell copolymer foam, such as closed cell ethylene-vinyl acetate (EVA) copolymer foam. The closed-cell copolymer foam may include a polymeric blend. The polymeric blend may include, for example, EVA and polyethylene (PE).

In some aspects of the present disclosure, the vehicle step assembly includes a stepping platform. The stepping platform defines a top platform surface, a bottom platform surface, and a side platform surface. The stepping platform may be movably coupled to the vehicle. The vehicle step assembly includes at least one light source coupled to the top platform surface of the stepping platform. For example, the vehicle step assembly may include a first light source coupled to the top platform surface, a second light source coupled to the bottom platform surface, and/or a third light source coupled to the side platform surface.

In some aspects of the present disclosure, the vehicle step assembly may include a housing connectable to the underside of the vehicle. The stepping platform is movable between the stowed position and a deployed position. The stepping platform is at least partially disposed inside the housing in the stowed position. The housing may be color matched with the vehicle. The stepping platform may be movable solely in a vertical direction relative to the vehicle.

### BRIEF DESCRIPTION OF THE DRAWINGS

The drawings described herein are for illustration purposes only and are not intended to limit the scope of the present disclosure in any way.

FIG. 1 is a schematic perspective view of a retractable vehicle step assembly mounted on a vehicle, wherein the retractable vehicle step is shown in a retracted or stowed position.

FIG. 2 is a schematic perspective view of the retractable vehicle step assembly of FIG. 1 in an extended or deployed position.

FIG. 3 is a schematic diagram of a retractable vehicle step system including the retractable vehicle step assembly shown in FIG. 1 in communication with a portable electronic device.

FIG. 4 is a schematic side view of the retractable vehicle step of FIG. 1, including a closed-cell copolymer foam layer.

FIG. 5 is a schematic perspective view of a vehicle with a plurality of retractable vehicle step assemblies shown in FIG. 1.

FIG. 6 is a schematic perspective view of a vehicle including a vehicle stepping platform with light sources.

FIG. 7 is a schematic perspective view of a vehicle including a vehicle stepping platform with a low-profile housing.

FIG. 8 is a schematic side view of a vehicle including a vehicle stepping platform configured to move vertically, wherein the stepping platform is in a first vertical position.

FIG. 9 is a schematic side view of the vehicle of FIG. 8, wherein the vehicle stepping platform is in an intermediate position.

FIG. 10 is a schematic side view of the vehicle of FIG. 8, wherein the vehicle stepping platform is in a fully extended position.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings generally relate to a vehicle and a system for a vehicle. The vehicle may be any type of automobile, such as a car, truck, sports utility vehicle (SUV), commercial vehicle, or a combination thereof. The vehicle may include a system integrating one or more accessories into the vehicle. The accessories may be assembly as part of the vehicle by the Original Equipment Manufacturer (OEM), may be provided as a secondary aftermarket accessory, or a combination thereof. The accessories may include one or more lights, one or more latches, one or more actuators, one or more mirrors, one or more doors, one or more interior accessories, one or more exterior accessories, or a combination thereof.

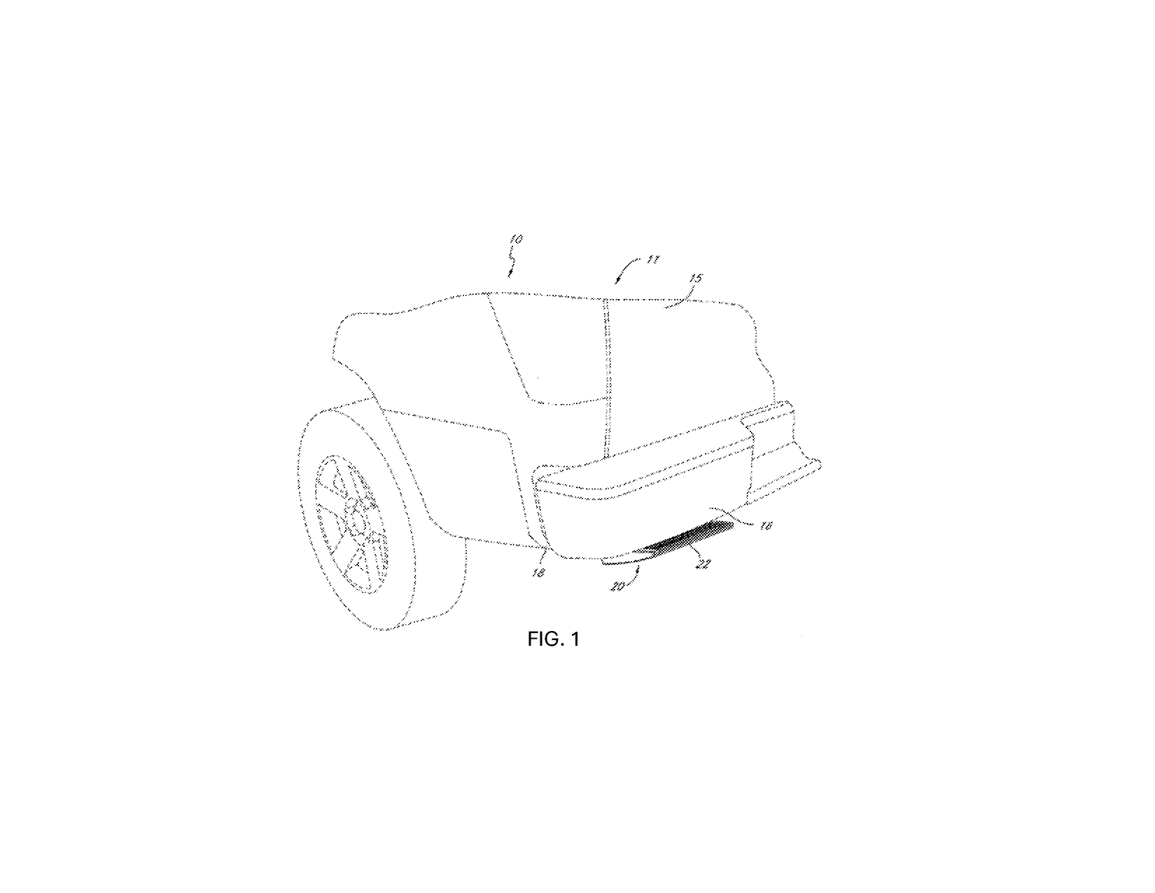

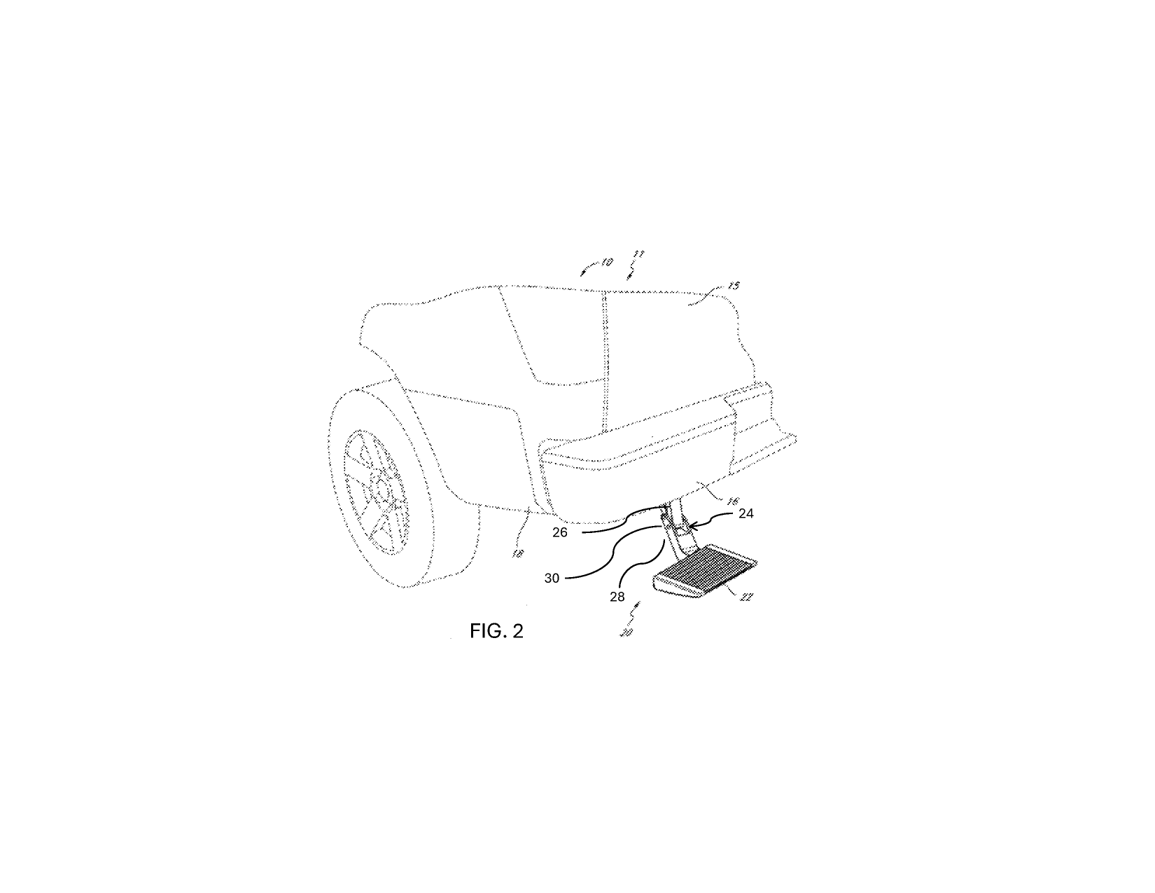

FIGS. 1 and 2 show different positions of certain embodiments of a retractable vehicle step assembly 20 coupled to a vehicle 10 (e.g., pickup truck). Specifically, in the depicted embodiment, the retractable vehicle step assembly 20 is coupled to the vehicle rear portion or end 11. However, the retractable vehicle assembly 20 may be mounted to other parts of the vehicle 10 as detailed below. The vehicle rear portion 11 may include a tailgate 15, a bumper 16, and a rear underbody, chassis or frame 18. The retractable vehicle step assembly 20 may be directly or indirectly attached to the rear underbody, chassis or frame 18 of the vehicle 10 using, for example, already existing connection members (e.g., trailer hitch bolts or the like) on the vehicle 10 to facilitate access to the vehicle cargo bed from the rear of the vehicle 10. Alternatively (or additionally), the retractable vehicle step assembly 20 may be attached to an underbody on the side of the vehicle 10 to facilitate access to the cargo bed from the side of the vehicle 10 as detailed below.

With continued reference to FIGS. 1 and 2, the retractable vehicle step assembly 20 includes a retractable vehicle step 22 and a linkage 24 coupled between the step 22 and the rear underbody 18. The linkage 24 allows the retractable vehicle step 22 to move relative to the vehicle 10 between a retracted or stowed position (FIG. 1) and a deployed position (FIG. 2). In the retracted position, the retractable vehicle step 22 is generally positioned below and within the projection of the horizontal perimeter of the bumper 16. In transitioning from the stowed position to the deployed position, the retractable vehicle step 22 exits the vehicle rear portion 11 of the vehicle 10 from below the bumper 16 and advantageously provides a stepping assist, with tailgate and/or bumper clearance, for a user to access the cargo bed of the vehicle 10. For example, the vehicle step 22 may move down and/or rearward relative to the vehicle rear portion 11 when transitioning to the deployed position. That is, while transitioning between the stowed position and the deployed position, the retractable vehicle step 22 may be displaced laterally, longitudinally and vertically relative to the rear underbody 18 of the vehicle 10. In the deployed position, the retractable vehicle step 22 may drop between four inches and six inches from the stowed position. Moreover, the retractable vehicle step 22 may include one or more removable tread plates to enhance friction between a user shoe and the retractable vehicle step 22 when the user steps on the retractable vehicle step 22. Additionally, the retractable vehicle step 22 may include lighting for illumination.

As shown in FIG. 2, as mentioned above, the linkage 24 (directly or indirectly) couples the retractable vehicle step 22 to the rear underbody 18 of the vehicle. In certain embodiments, the linkage 24 includes an upper arm 26 and a lower arm 28 pivotally coupled to each other to allow the retractable vehicle step 22 to move relative to the vehicle 10 between the stowed position (FIG. 1) and the deployed position (FIG. 2). One or more pivot fasteners 30 (e.g., pivot pin, pivot bolt, etc.) may pivotally interconnect the upper arm 26 and the lower arm 28. As a non-limiting example, the linkage 24 may include the features described in U.S. Patent No. 8,827,294, entitled “Retractable Vehicle Step,” the entire contents of which are incorporated by reference herein.

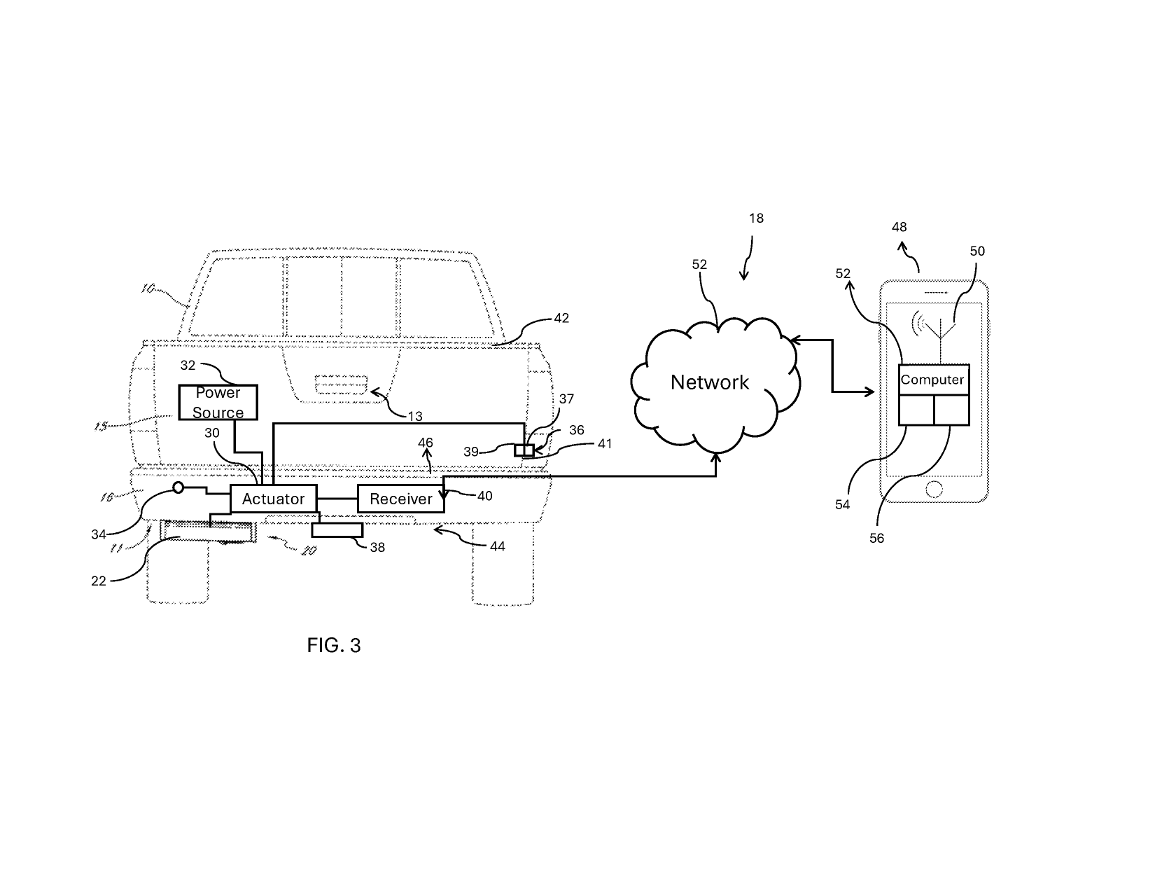

With reference to FIG. 3, the retractable vehicle step assembly 20 includes an actuator 30 mechanically coupled to the retractable vehicle step 22. As such, upon actuation, the actuator 30 moves the retractable vehicle step 22 between the stowed position (FIG. 1) and the deployed position (FIG. 2). As non-limiting examples, the actuator 20 may be a solenoid actuator, an electric motor (e.g., a stepper motor, a servomotor, etc.), a hydraulic actuator, a pneumatic actuator, among others. Regardless of its type, the actuator 30 drives the retractable vehicle step 22, thereby allowing the retractable vehicle step 22 to transition between the stowed position (FIG. 1) and the deployed position (FIG. 2). The actuator 30 is operatively coupled to a power source 32 (e.g., electric power source). Thus, the power source 32 supplies power, such as electric power, to the actuator 30. As non-limiting examples, the power source 32 may be an electric power source, such as a battery. In such case, the power source 32 supplies electrical energy to the actuator 30. It is envisioned, however, that the power source 32 may supply other types of power to the actuator 30, such as pneumatic power or hydraulic power. The power source 32 may be part of the vehicle 10 and may therefore supply power to other components of the vehicle 10. Alternatively, the power source 32 may be solely dedicated to power the actuator 30 of the retractable vehicle assembly 20.

With continued reference to FIG. 3, the retractable vehicle step assembly 20 may further include an input device to activate the actuator 30 to move the retractable vehicle step 22 between the stowed position (FIG. 1) and the deployed position (FIG. 2). A user may engage the input device to activate the actuator 30. As non-limiting examples, the input device may be a button 34, a switch 36, a sensor 38 (e.g., a motion sensor), and/or a receiver 40 (e.g., radiofrequency (RF) signal receiver).

In certain aspects of the present disclosure, the button 34 is connected (e.g., electrically connected) to the actuator 23. Therefore, pushing the button 34 may activate the actuator 30. Upon activation of the actuator 354, the retractable vehicle step 22 moves between the stowed position (FIG. 1) and the deployed position (FIG. 2). In the depicted embodiment, the button 34 is attached to the bumper 16. It is envisioned, however, that the button 34 may be positioned at different locations of the vehicle 10. For example, the button 34 may be part of the instrument panel of the vehicle 10. In another example, the button 34 may be disposed inside the cargo space of the vehicle 10.

In some aspects of the present disclosure, the switch 36 may be considered a sensor (e.g., sensor 38) and is connected (e.g., electrically connected) to the actuator 30. As a non-limiting example, the switch 36 may be a magnetic switch coupled to a bed wall 41 of the vehicle cargo bed. The magnetic switch includes a first switch portion 37 directly coupled to the bed wall 41 of the vehicle cargo bed and a second switch portion 39 directly coupled to tailgate 15. When the tailgate 15 is in the closed position, the magnetic switch is in its closed state, and the actuator 30 is not activated. As the tailgate 15 moves from the closed position to the open position, the magnetic switch transitions from the closed state to the open state. When the magnetic switch is in the open state, the actuator 30 activates and moves the retractable vehicle step 20 from the stowed position to the deployed position. Further, as the magnetic switch transitions from the open state to the closed state, the actuator 30 activates to move the retractable vehicle step 22 from the deployed position (FIG. 2) to the stowed position (FIG. 1).

In some aspects of the present disclosure, the switch 36 may be integrated with a tailgate handle 13 of the tailgate 15. The tailgate handle 13 is used to open the tailgate 15, for example, by operating a tailgate latch. Engaging the tailgate handle 13 activates the switch 36, causing actuator 30 to actuate. Upon actuation of the actuator 30, the retractable vehicle step 22 moves between the stowed position (FIG. 1) and the deployed position (FIG. 2). The switch 36, however, may be located in other parts of the vehicle 10, such as the instrument panel. As non-limiting examples, the switch 36 may be touch switch (e.g., capacitance switch, a resistance touch switch, or a piezo touch switch). The switch 36 may be a biased switch. In such case, the user may engage and hold the switch 35 to activate the actuator 30, thereby moving the retractable vehicle step 22 from the stowed position (FIG. 1) to the deployed position (FIG. 2). Upon release of the switch 36, the actuator 30 deactivates, causing the retractable vehicle step 22 to move from the deployed position (FIG. 2) to the stowed position (FIG. 1).

In addition to the switch 36, the actuator 30 may be activated using a sensor 38. The sensor 38 may be a motion sensor, for example. The motion sensor may detect motion of a nearby user. For instance, the sensor 38 (e.g., motion sensor) may be attached to the bottom surface 44 of the bumper 16 or another suitable component of the vehicle 10. To trigger the sensor 38, the user may position the foot under the bumper 16 or another part of the vehicle 10, causing the sensor 38 (e.g., the motion sensor) to detect movement under the bumper 16. In response to detecting motion under the bumper 16, the actuator 30 activates, driving the retractable vehicle step 22 to move between the stowed position (FIG. 1) and the deployed position (FIG. 2). While FIG. 3 shows the sensor 38 attached to the bumper 16, the sensor 38 may be attached to other parts of the vehicle 10. The sensor 38 may be coupled to a bed inner wall of the cargo compartment of the vehicle 10. Further, the sensor 38 may be another type of sensor (i.e., other than a motion sensor). In other example, the sensor may also be coupled to an underside of the step 22. In some instances, more than one sensor may be provided, each sensor positioned at different locations.

In another example, the sensor 38 may be a proximity sensor that detects the presence of a specific nearby object, such as a key fob or a smartphone, at a predetermined distance from the vehicle 10. The proximity sensor is configured to detect that the specific object is within the predetermined distance and, in response, sends a control signal to the actuator 30. In response to receiving the control signal from the sensor 38, the actuator 30 actuates and moves the retractable vehicle step 22 between the stowed position (FIG. 1) and the deployed position (FIG. 2). As non-limiting examples, the proximity sensors may be a capacitive proximity sensor, an inductive proximity sensor, a photoelectric proximity sensor, a magnetic proximity sensor, or an ultrasonic proximity sensor.

In yet another example, the sensor 38 may be a pressure sensor (e.g., piezoelectric pressure sensor) capable of detecting a predetermined magnitude of pressure applied on a bed cap 42 of the tailgate 15 and/or an upper surface 46 of the bumper 16. During use, the user may place a heavy item on the bed cap 42 of the tailgate 15 or on the upper surface 46 of the bumper 16. In such a case, the pressure sensor detects that the heavy item is applying a pressure that is greater than a predetermined threshold. In response, the pressure sensor sends a control signal to the actuator 30. Upon receipt of the control signal from the pressure sensor, the actuator 30 activates, causing the retractable vehicle step 22 to move from the stowed position (FIG. 1) to the deployed position (FIG. 2).

With continued reference to FIG. 3, the retractable vehicle step assembly 20 may additionally (or alternatively) include the receiver 40, which is configured to wirelessly receive a signal from a portable electronic device 48 or another suitable device. The receiver 40 is in communication with the actuator 30 and, upon receipt of a control signal by the receiver 40, the actuator 30 actuates, causing the retractable vehicle step 22 to move between the stowed position (FIG. 1) and the deployed position (FIG. 2). The control signal received by the receiver 40 may be generated by the portable electronic device 48. As non-limiting examples, the portable electronic device 48 may be a smartphone, a tablet, or a laptop.

The portable electronic device 48 may be considered part of a retractable vehicle step system 18. The vehicle step system 18 includes the retractable vehicle step assembly 20 and the portable electronic device 48. The portable electronic device 48 includes a transmitter 50 configured to transmit signals through a wireless network 52. Accordingly, the transmitter 50 may include one or more antennas to transmit signals. The receiver 40 may include one or more antennas to receive signals. The transmitter 50 and the receiver 40 may be configured to communicate via a wireless local area network (WLAN) using IEEE 802.11 standards or by using cellular data communication. However, additional or alternate communication methods, such as Ultra-wideband (UWB) and BLUETOOTH wireless technologies, are also considered within the scope of the present disclosure. Other known, suitable, wireless communication technologies are envisioned as well.

The portable electronic device 48 also includes one or more computers 52 (or computing devices) in communication with the transmitter 50. As such, the computer 52 may command the transmitter 50 to transmit signals to the receiver 40. Computers 52 and computing devices generally include computer executable instructions, where the instructions may be executable by one or more computing devices. Computer executable instructions may be compiled or interpreted from computer programs created using a variety of programming languages and/or technologies, including, without limitation, and either alone or in combination, JAVA, PYTHON, C, C++, MATLAB, SIMULINK, STATEFLOW, VISUAL BASIC, JAVA SCRIPT, PERL, HTML, etc. Some of these applications may be compiled and executed on a virtual machine, such as the JAVA VIRTUAL MACHINE, THE DALVIK VIRTUAL MACHINE, or the like.

The computer 52 includes one or more processors 54 and one or more non-transitory computer readable media 56 in communication with the processors 54. In general, the processor 54 (e.g., a microprocessor) receives instructions, e.g., from a memory, a computer readable medium (e.g., non-transitory computer readable media 56), etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc. The processor 54 may be a custom-made processor, a central processing unit (CPU), a graphics processing unit (GPU), an auxiliary processor among several processors associated with the computer 52, a semiconductor-based microprocessor (in the form of a microchip or chip set), a macroprocessor, a combination thereof, or generally a device for executing instructions. The computer 52 may alternatively be referred to as a controller or control circuitry.

Memory may include the non-transitory computer readable medium 56 (also referred to as a processor readable medium) that includes any non-transitory (e.g., tangible) medium that participates in providing data (e.g., instructions) that may be read by the computer 52 (e.g., by a processor 54 of the computer 52). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to the processor 52. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which the computer 52 can read.

The computer 52 is programmed to run one or more applications. The application is configured to receive inputs (e.g., commands) from a user. For example, the user may command the retractable vehicle step 22 (through the application running on the computer 52) to move from the retractable vehicle step 22 from the stowed position to the deployed position, or vice-versa. In response to receiving this input from the user, the computer 52 commands the transmitter 52 to send a control signal to the receiver. The control signal is indicative of the command requested by the user. Upon receipt of the control signal by the receiver 40, the actuator 30 activates, causing the retractable vehicle step 22 to move from the stowed position (FIG. 1) to the deployed position (FIG. 2), or vice-versa.

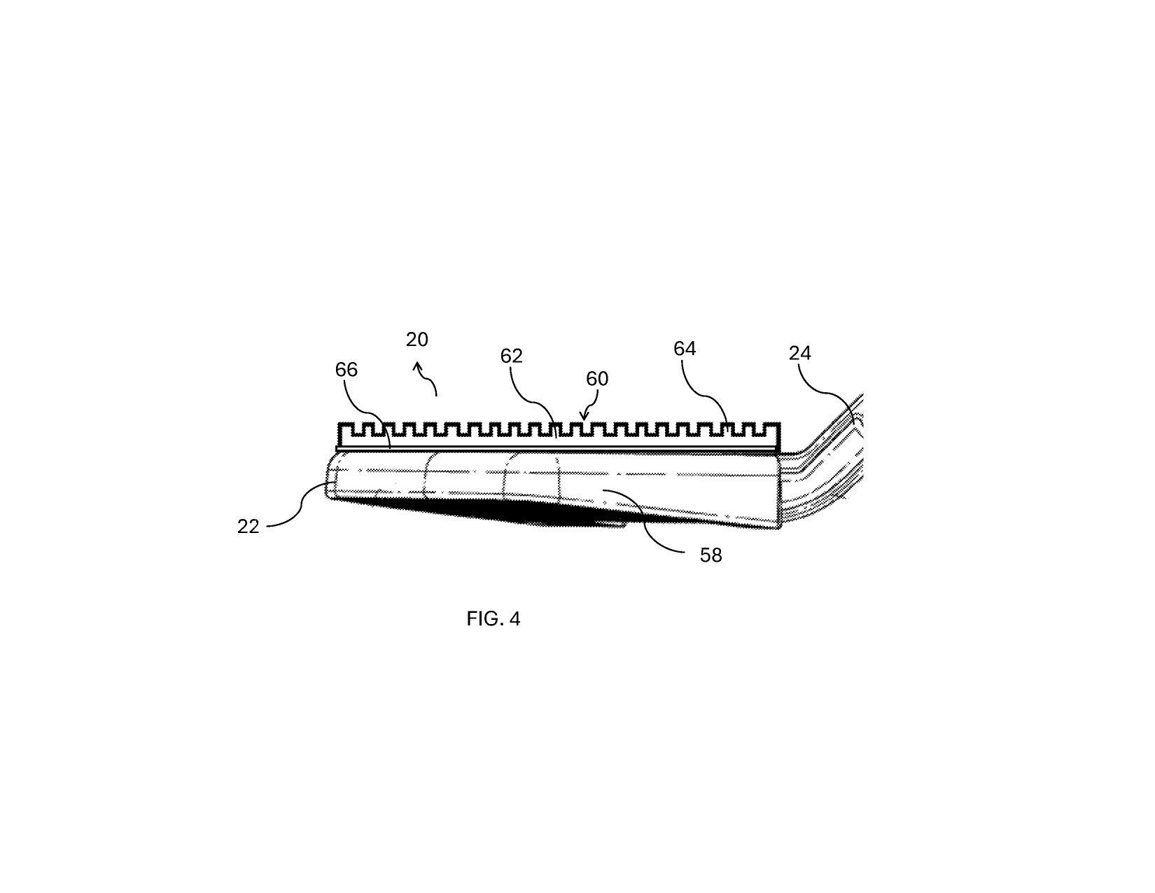

With reference to FIG. 4, the retractable vehicle step 22 of the retractable vehicle step assembly 20 includes a step body 58 and the linkage 24. The step body 58 defines an uppermost surface 60 and may be wholly or partly made of a metallic material sufficiently strong to support the weight of an average person. As non-limiting examples, the step body 58 may be wholly or partly made of aluminum or stainless steel. Alternatively, the step body 58 may be partly or wholly made of Acrylonitrile butadiene styrene (ABS) plastic. Regardless of the material used for the step body 58, the retractable vehicle step 22 may additionally include a stepping layer 62 disposed on top the uppermost surface 60. The stepping layer 62 may have threads 64 to enhance friction with a shoe when the user steps on the retractable vehicle step 22. It is contemplated that the stepping layer 62 may be wholly or partly of a polymeric material, such as a closed-cell copolymer foam, to provide several benefits, namely: anti-slip grip, weather resistant, durability, lightweight, heat resistance, and recyclable. To provide of these benefits, the closed-cell copolymer foam may be, for example, a closed cell ethylene-vinyl acetate (EVA) copolymer foam or a closed-cell copolymer foam having a polymeric blend including EVA and polyethylene (PE). The stepping layer 62 may be removably coupled to the step body 58 to allow user customization. For example, the specific colors and aesthetic design of the stepping layer 62 may vary. A suitable connection mechanism may be used to removably couple the stepping layer 62 to the step body 58. For example, a removable adhesive layer 66 may be used to adhere the stepping layer 62 to the step body 58. Also, other removable fasteners, such as hook and loop fasteners, screws, and bolts, may be used to couple the stepping layer to the step body 58.

FIG. 5 shows the vehicle 10 including a plurality of retractable vehicle step assemblies 20. Each retractable vehicle step assembly 20 is attached to the underbody, chassis or frame 18 of the vehicle 10 using, for example, already existing connection members (e.g., trailer hitch bolts or the like). The vehicle 10 may include five retractable vehicle step assemblies 20. However, the vehicle 10 may include more or fewer retractable vehicle step assemblies 20. One retractable vehicle step assembly 20 may be mounted to the rear of the vehicle 10, and other retractable vehicle step assemblies 20 may be mounted adjacent to each vehicle door 68. Another retractable vehicle step assembly 20 may be mounted to the front of the vehicle 10 to facilitate access to the hood. Irrespective of the number of retractable vehicle step assemblies 20, each retractable vehicle step assembly 20 may be manually adjusted to reach a particular height when disposed in the deployed position, thereby allowing customization for the height preference of each individual user. In addition, the retractable vehicle step assemblies 20 may be operated independently from each other. Thus, one retractable vehicle step assembly 20 may remain stationary, while another retractable vehicle step assembly 20 transitions between the stowed position and the deployed position. Each of the retractable vehicle step assemblies 20 may be operated with the button 34, the switch 36, the sensor 38, and/or an app running on the portable electronic device 48, as described above. For example, one or more sensors 38 may be positioned adjacent to each vehicle door 68 and may function as a door sensor configured to sense a door status (e.g., open vehicle door or closed vehicle door) of each vehicle door 65. As a non-limiting example, the sensor 38 may be a magnet switch and is configured to generate a status signal indicative of the door status. The actuator 30 is configured to actuate to move the retractable vehicle step 22 from the stowed position to the deployed position in response to receiving the status signal indicative that the vehicle door 68 is open. In addition, the actuator 30 is configured to actuate to move the retractable vehicle step 22 from the stowed position to the deployed position in response to receiving the status signal indicative that the vehicle door 68 is closed. The app executed by the portable electronic device 48 may save user profiles for each individual user. The saved user profiles may include the preferred step height for each user. Therefore, each user may select a particular user profile in order to move the retractable vehicle step 22 from the stowed position to the preferred step height saved under the selected user profile.

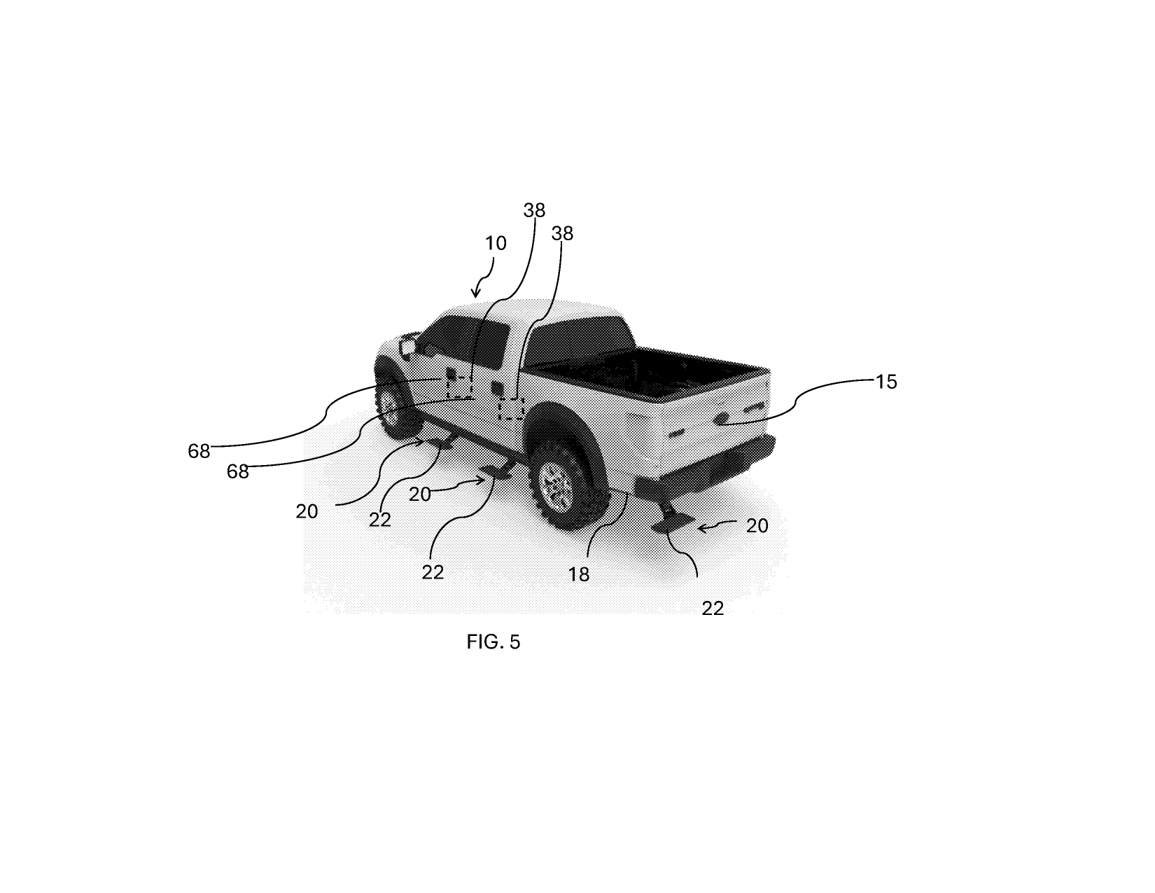

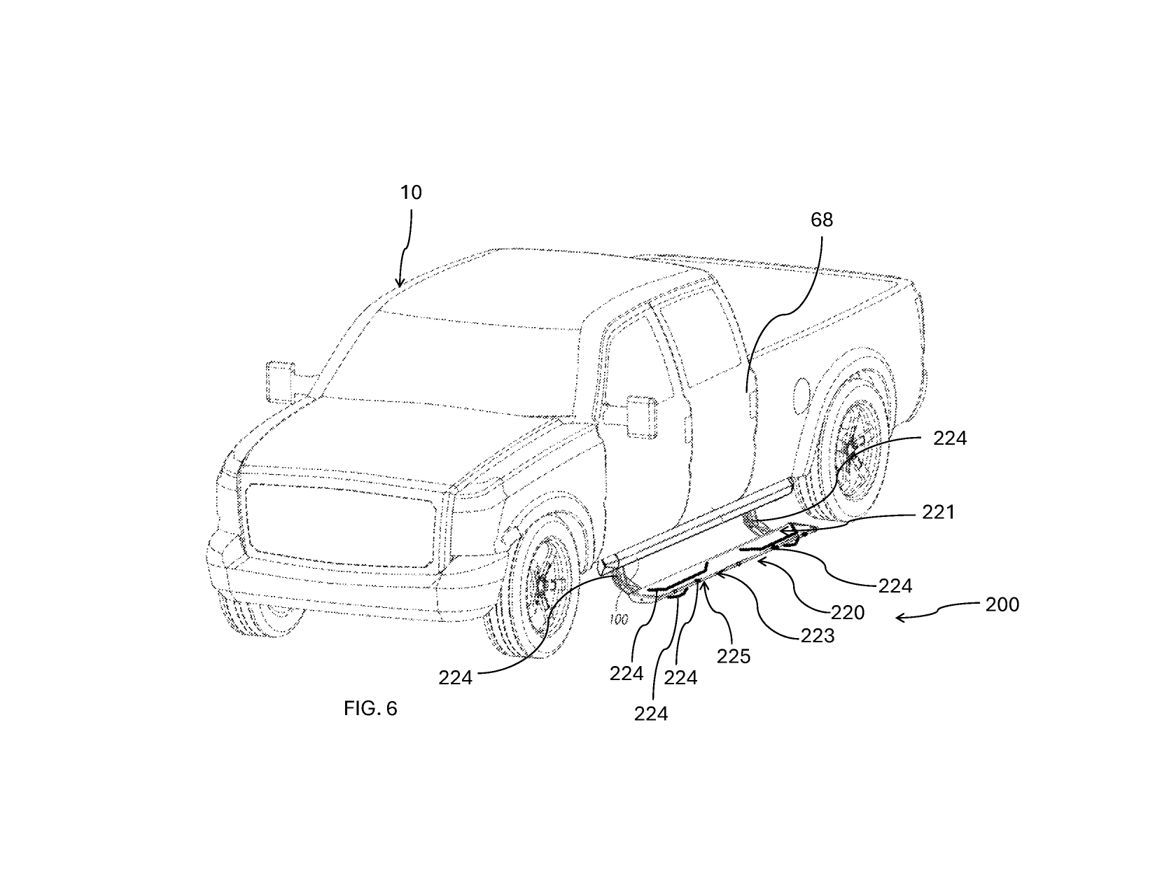

With reference to FIG. 6, a retractable vehicle step assembly 200 is coupled to the side of the vehicle 10. The vehicle step assembly 200 includes a stepping platform 200 movably relative to the vehicle 10 between a stowed position and a deployed position. In the stowed position, the stepping platform 200 is at least partially hidden inside a side bar 100. The stepping platform 220 may be configured as a running board and extends along at least two vehicle doors 68 on the side of the vehicle 10. The retractable vehicle step assembly 200 includes a linkage 224 coupled between the stepping platform 220 and the underside of the frame of the vehicle 10. As a non-limiting example, the linkage 224 of the retractable vehicle step assembly 200 may include the features described in U.S. Patent No. 9,550,458, entitled “Retractable Vehicle Step, and Side Bar Assembly for Raised Vehicle,” the entire contents of which are incorporated by reference herein.

The linkage 224 may be operatively coupled to an actuator 30, as described above with respect to the retractable vehicle step assembly 20 of FIG. 3, to move the stepping platform 200 between the stowed position and the closed position. Each of the retractable vehicle step assemblies 200 may be operated with the app running on the portable electronic device 48, the button 34, the switch 36, the sensor 38 as described above with respect to the respect to the retractable vehicle step assembly 202 of FIG. 3. The stepping platform 220 defines a top platform surface 221, a side platform surface 223, and a bottom platform surface 225. The stepping platform 220 may include one or more light sources 224 at different locations to illuminate the user pathway during user entry to the vehicle passenger compartment through the vehicle door 68. For example, one or more light sources 224 may be attached to the top platform surface 221. One or more light sources 224 may be attached to the bottom platform surface 223 to illuminate the ground, thereby facilitating user entry into the vehicle 10 at night. Further, one or more light sources 224 may be attached to the side platform surface 223 for, among other things, aesthetic appeal. The stepping platform 220 may include the light sources 224 to customize the vehicle 10. The light sources 224 may be activated sequentially. Alternatively, the light sources 224 may change colors and patterns according to the user’s preferences. The user may employ the application running on the portable electric device 48 (FIG. 3) to customize the color and pattern of the light sources 224. The light sources 224 may also be programmed to work in unison with the hazard lights and/or the turn signals of the vehicle 10. The stepping platform 220 may include a removable upper tread plate that includes the light sources 224 to facilitate customization of the vehicle 10. The user may design their own removable tread plate according to their preference. The stepping layer 62 described above with respect to FIG. 4 may be removably coupled to the stepping platform 220.

In some examples, the light sources 224 may be embedded in the stepping platform 220 or recessed from an outer surface such as 221, 223, 225. In some examples, the stepping platform 220 may include one or more sections of transparent or translucent material through which light from the light sources 224 may be transmitted. Alternatively, the stepping platform may include one or more openings through which light may be transmitted. In still other examples, the light sources 224 may be provided between an upper tread plate and the top platform surface. The upper tread plate may include one or more transparent or translucent sections, and/or openings, through which light may be transmitted. In further examples, light refracting and/or reflecting surfaces may be included or added to the light sources 224, stepping platform 220 and/or upper tread plate to provide different lighting effects.

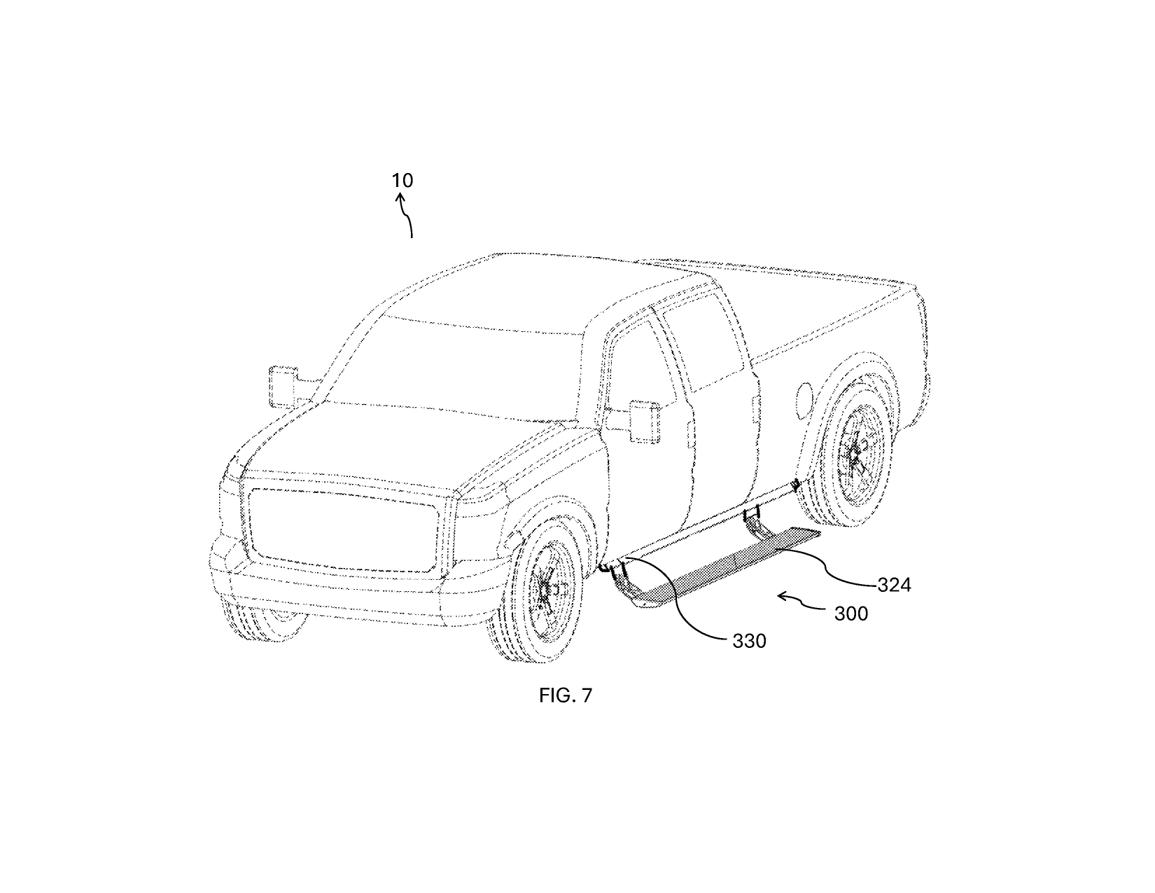

With reference to FIG. 7, a retractable vehicle step assembly 300 is coupled to the side of the vehicle 10. The retractable vehicle step assembly 300 includes a stepping platform 324 movably relative to the vehicle 10 between a stowed position and a deployed position as discussed above with respect to FIG. 6. As a non-limiting example, the linkage 224 of the retractable vehicle step assembly 200 may include the features described in U.S. Patent No. 9,550,458, entitled “Retractable Vehicle Step, and Side Bar Assembly for Raised Vehicle” the entire contents of which are incorporated by reference herein. However, in the stowed position, the stepping platform 324 of the retractable vehicle step assembly 300 includes a low-profile housing 330. The low-profile housing 330 may be configured as a small box or outer fascia that helps hide the stepping platform 200 in the stowed position. The housing 330 may be attached to the underside of the vehicle 10 with a prefabricated bracket system through a mounting plate. When attached to the vehicle 10, the housing 330 is always visible regardless of whether the stepping platform 324 is in the deployed position or the stowed position. Due to this visibility, the housing 330 may be color matched with the vehicle 10. Alternatively, the housing 330 may be partly or wholly made of a transparent material.

When in the stowed position, the stepping platform 330 is disposed contiguous with the housing 330, thereby allowing the retractable vehicle step assembly 300 to function as a rock rail and visually appear as part of the vehicle 10. In some examples, the vehicle step assembly 300 may be received within and/or enclosed by the housing 330. The retractable vehicle step assembly 300 may include one or more light sources 224 as discussed above with respect to FIG. 6. Moreover, the stepping layer 62 described above with respect to FIG. 4 may be removably coupled to the stepping platform 220.

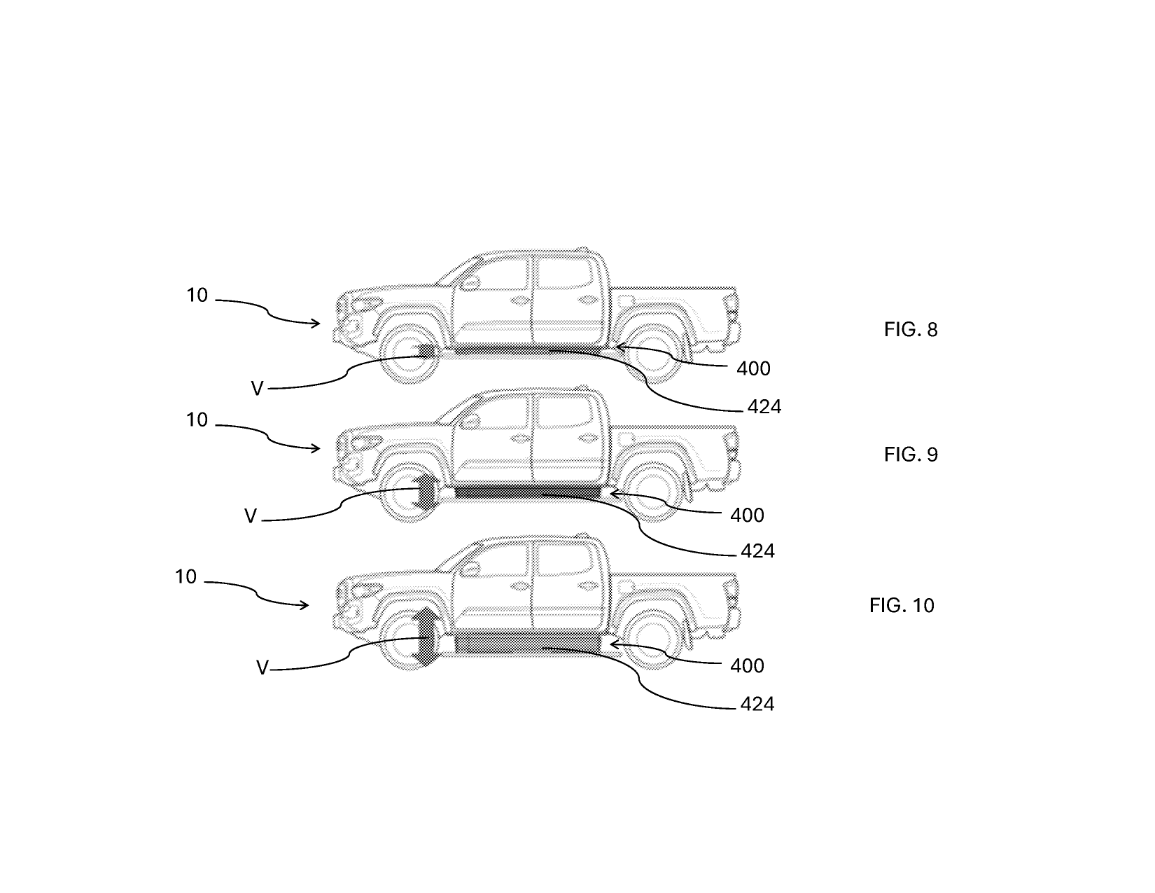

With reference to FIGS. 8, 9, and 10, a vertically movable step assembly 400 may be configured to always function as a running board and is attached to an underside of the vehicle 10. The vertically movable step assembly 400 includes a stepping platform 424 extending from the front to the rear wheels to facilitate entry into the vehicle passenger compartment by multiple people. The stepping platform 424 does not move into a stowed or hidden position. Rather, the stepping platform 424 of the step assembly 400 solely moves vertically (in the direction indicated by double arrows V) relative to the vehicle 10, and/or substantially perpendicular to a plane on which the wheels lie. In some embodiments, the stepping platform 424 may move vertically and horizontally. In the depicted embodiment, the stepping platform 432 is vertically movable between a first vertical position or closed position (FIG. 8) to a second vertical or fully extended position (FIG. 10) relative to the vehicle 10. In the closed position, the stepping platform 424 is closest to the underside of the vehicle 10 in relation to the other vertical positions. In the fully extended position, the stepping platform 424 is farthest from the underside of the vehicle 10 in relation to the other vertical positions. Additionally, the stepping platform 424 may remain stationary at a plurality of intermediate vertical positions (FIG. 9) between the closed position and the fully extended position). An app running on the electronic device 48 (FIG. 3) may control the operation and movement of the vertically movable step assembly 400 as described above with respect to FIG. 3. A user may save a user profile on the app, and the user profile includes the predefined position of the stepping platform relative to the vehicle 10 for each user. Specifically, the app executed by the portable electronic device 48 (FIG. 3) may save user profiles for each individual user. The saved user profile may include the preferred step height for each user (i.e., a preferred position for the stepping platform 424). Therefore, each user may select their user profile to move the stepping platform 424 from the closed position to the predefined position saved under the selected user profile. The stepping platform 424 may include one or more light sources 224 as discussed above with respect to FIG. 6. Moreover, the stepping layer 62 described above with respect to FIG. 4 may be removably coupled to the stepping platform 424. It will be appreciated that such functionality and operability may be provided for vehicle steps at different locations on the vehicle, for example at the rear of the vehicle or side of the truck bed.

An appendix is enclosed herein and is part of the present disclosure.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps. The disclosure of "a" or "one" to describe an element or step is not intended to foreclose additional elements or steps.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100 +/- 15.

In the descriptions above and in the claims, phrases such as “at least one of or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

The disclosures of all articles and references, including patent applications and publications, are incorporated by reference for all purposes. Other combinations are also possible as will be gleaned from the following claims, which are also hereby incorporated by reference into this written description.

What is claimed is:

1. A retractable vehicle step assembly for a vehicle, comprising:
a retractable vehicle step movably coupled to the vehicle, wherein the retractable vehicle step is movable relative to the vehicle between a stowed position and a deployed position;
an actuator coupled to the retractable vehicle step, wherein the retractable vehicle step is configured to move between the stowed position and the deployed position upon activation of the actuator;
a sensor in communication with the actuator, wherein the sensor is configured to detect an event and generate a control signal upon detection of the event, and the sensor is configured to transmit the control signal to the actuator in response to detecting the event; and
wherein the actuator is configured to actuate in response to receiving the control signal from the sensor to move the retractable vehicle step between the stowed position and the deployed position.

2. The retractable vehicle step assembly of claim 1, wherein the sensor is a motion sensor configured to detect a movement of a user.

3. The retractable vehicle step assembly of claim 2, wherein the motion sensor is attached to a bottom surface of a bumper of a vehicle to detect a foot motion of the user under the bumper of the vehicle.

4. The retractable vehicle step assembly of claim 1, wherein the control signal is originated from a portable electronic device located remotely relative to the vehicle, and the retractable vehicle step assembly further includes a receiver configured to wirelessly receive the control signal from the portable electronic device.

5. The retractable vehicle step assembly of claim 4, wherein the portable electronic device includes a computer and a transmitter in communication with the computer, the computer includes a processor and a non-transitory computer readable medium in communication with the processor, the computer is programmed to run an application to command the transmitter to wirelessly transmit the control signal to the receiver in response to receiving an input from a user.

6. The retractable vehicle step assembly of claim 1, wherein the sensor is a magnetic switch coupled to a tailgate of the vehicle, the tailgate is movable between an open position and a closed position, and the magnetic switch is configured to detect when the tailgate moves between the open position and the closed position.

7. The retractable vehicle step assembly of claim 6, wherein the magnetic switch is configured to transmit the control signal to the actuator in response to detecting a movement of the tailgate between the open position and the closed position, and the actuator is configured to actuate in response to receiving the control signal from the magnetic switch to move the retractable vehicle step between the stowed position and the deployed position.

8. The retractable vehicle step assembly of claim 1, wherein retractable vehicle step includes a step body, the step body has an uppermost surface, the step body is made of a metallic material, the retractable vehicle step assembly further includes a stepping layer disposed on top the uppermost surface of the step body, the stepping layer is removable from the step body, the stepping layer is made of a polymeric material, and the stepping layer has a plurality of threads.

9. The retractable vehicle step assembly of claim 8, wherein the polymeric material is a closed-cell copolymer foam.

10. The retractable vehicle step assembly of any of claim 9, wherein the closed-cell copolymer foam is a closed cell ethylene-vinyl acetate (EVA) copolymer foam.

11. The retractable vehicle step assembly of claim 9, wherein the closed-cell copolymer foam includes a polymeric blend, and the polymeric blend includes ethylene-vinyl acetate (EVA) and polyethylene (PE).

12. The retractable vehicle step assembly of claim 1, further comprising at least one light source attached to the retractable vehicle step.

13. The retractable vehicle step assembly of claim 1, wherein the retractable vehicle step assembly is configured to be coupled adjacent to a tailgate of the vehicle.

14. The retractable vehicle step assembly of any of claim 1, wherein the retractable vehicle step assembly is configured to be coupled adjacent to a vehicle door of the vehicle.

15. A vehicle step assembly for a vehicle, comprising:
a stepping platform movably coupled to the vehicle, wherein the stepping platform is movable relative to the vehicle, and the stepping platform defines a top platform surface, a side platform surface, and a bottom platform surface; and
at least one light source coupled to the top platform surface of the stepping platform.

16. The vehicle step assembly of claim 15, wherein the at least one light source is a first light source, and the vehicle step assembly further includes a second light source coupled to the bottom platform surface.

17. The vehicle step assembly of claim 16, further comprising a third light source coupled to the side platform surface.

18. The vehicle step assembly of claim 15, further comprising a housing connectable to the underside of the vehicle, wherein the stepping platform is movable relative to the housing between a stowed position and a deployed position, and the stepping platform is at least partially disposed inside the housing in the stowed position.

19. The vehicle step assembly of claim 18, wherein the housing is color matched with the vehicle.

20. The vehicle step assembly of claim 15, wherein the stepping platform is movable solely in a vertical direction relative to the vehicle.
